(19) United States
(12) Patent Application Publication
(10) Pub. No.: US 2026/0010663 A1
(43) Pub. Date: Jan. 8, 2026

(54) METHOD FOR COMPUTER-AIDED DESIGN OF A BRUSH FOR A COSMETIC PRODUCT APPLICATOR, AND ASSEMBLY FOR PRODUCING SUCH A BRUSH

(71) Applicant: SOCIETE INDUSTRIELLE DE MATIERES PLASTIQUES, TIGERY (FR)

(72) Inventor: Eric DE BARDONNECHE, MONTAREN-ET-SAINT-MEDIERS (FR)

(21) Appl. No.: 18/992,225

(22) PCT Filed: Aug. 12, 2022
(86) PCT No.: PCT/FR2022/051582

§ 371 Date: Jan. 8, 2025

(51) Int. Cl. G06F 30/10; G06F 111/04; G06F 111/20

(52) U.S. Cl. CPC G06F 30/10; G06F 2111/04; G06F 2111/20

(57) ABSTRACT

The invention relates to a method for computer-aided design of an applicator brush, the brush comprising a plurality of applicator segments. The method comprises the following steps: providing a database comprising a plurality of applicator segments; providing compatibility rules; selecting a first applicator segment; defining, from the database and on the basis of the compatibility rules, a first set of applicator segments compatible with the first applicator segment and selecting at least one applicator segment from the first set.

### TECHNICAL FIELD

The invention relates to brushes for cosmetic product applicators and to methods for designing such brushes.

The subject of the invention is thus a computer-aided design method for designing an applicator brush, a method for manufacturing such a brush, a manufacturing assembly for manufacturing this same brush, and a program product.

### PRIOR ART

The designing of brushes for cosmetic product applicators is a relatively complex process and may prove to be lengthy and expensive. Specifically, such a design process generally progresses through the construction of a number of prototypes, each of these prototypes entailing manufacturing or adapting the molds used to produce them. The mold-manufacture or mold-adaptation operations are themselves lengthy and expensive, and this is why such design lead-times are relatively long.

A “brush for a cosmetic product applicator” refers hereinabove and in the rest of this document both to brushes comprising spikes distributed over the entirety of its periphery, such as “conventional” mascara brushes, and brushes having spikes over just part of their periphery and brushes, more generally referred to as combs, having just one row of spikes. It will be noted that such brushes are intended to apply any type of cosmetic product to part of the body of a user, these body parts notably including keratin fibers such as eyelashes, the lips, or else areas of skin.

In order to reduce the lead times and costs associated with such brush design, it is conceivable to use additive manufacturing. This is because such manufacturing offers the advantage of not requiring a mold. Nevertheless, additive manufacturing is not entirely suitable for the production of brushes in the context of the application of a cosmetic product. Specifically, in addition to the fact that the production lead-times when manufacturing each example of a prototype are relatively long, the materials available are few in number and not necessarily those best suited to such an application. Thus, with additive manufacturing methods, it is still not possible to manufacture the prototypes in the material that will be used for the final brush.

As an alternative to additive manufacturing, it is also possible to produce a brush from a production kit, as per the teachings of application EP 3893693 A1. While such a kit allows an applicator brush to be designed quickly, easily selecting the various applicator sectors that may make up the brush, it does have a certain number of disadvantages.

It will be noted that “applicator sector” hereinabove and in the rest of this document and in accordance with the teaching of document EP3893693 A1, refers to an angular sector of the applicator, the applicator extending axially about a longitudinal axis and being made up of N longitudinal angular sectors, with the vertex of each of these sectors coinciding with said longitudinal axis. Thus, when the sector comprises N sectors, an applicator sector corresponds to an angular sector subtending an angle of 360/N° so that by assembling the N applicator sectors distributed about the longitudinal axis, the applicator is obtained.

Such a kit is actually relatively complicated to use and, for an inexperienced designer, it is easy to design a brush that will not be able to be manufactured because of unsuitable molds. Adding to this problem regarding the feasibility of the brush designed are the difficulties in manipulating these applicator sectors. Thus, this solution is not itself entirely suitable.

### SUMMARY OF THE INVENTION

The invention seeks to overcome, at least partially, the abovementioned problems and its object is therefore to provide a design method that is both simpler and quicker to implement than the methods of the prior art.

The invention therefore relates to a method for the computer-aided design of a brush of a cosmetic-product applicator, the brush extending along a longitudinal axis and comprising a plurality of applicator sectors each representing an angular section of said brush about the longitudinal axis, the method comprising the following steps:
E1. provision of a database containing a plurality of applicator sectors and/or groups of applicator sectors suitable for contributing to the creation of the brush,
E2. provision of compatibility rules governing the mutual compatibility of the applicator sectors and/or groups of applicator sectors,
E3. user-selection of at least a first applicator sector or group of applicator sectors in the database,
E4. definition, from the database and on the basis of the compatibility rules, of a first set of applicator sectors and/or groups of applicator sectors that are compatible with the at least one first applicator sector or group of applicator sectors selected in step E3.,
E5. user-selection of at least one applicator sector and/or group of applicator sectors from the first set.

With such a method, designing an applicator brush becomes easy. Specifically, because the design rules are fixed beforehand, in step E2., the designer does not need to be experienced and whatever the brush this designer may design while implementing a method of the invention, this brush will be able to be manufactured. It will also be noted that this type of design that aims to produce the brush prototype, once designed, by molding, means that the brush can be manufactured quickly and easily in the appropriate material and with the number of individual examples needed, unlike in additive-manufacturing design methods. Such a procedure is of particular benefit in the context of a process of designing a brush, because it enables a drastic reduction in the time required between the production of a brush prototype and the actual manufacture of the brush, and therefore its test of application with the cosmetic product in a real-life situation (i.e. with human test subjects). It is therefore possible to adjust the brush prototype quickly in order to obtain the cosmetic-product-application properties sought.

The method may further comprise, after the step E5, the following steps:
E6. definition, from the database and on the basis of the compatibility rules, of a subsequent set of applicator sectors and/or groups of applicator sectors that are compatible with the applicator sector or the group of applicator sectors selected in the preceding selection step E5., E7.,
E7. user-selection of at least one subsequent applicator sector and/or group of applicator sectors from the subsequent set,
E8. verification whether the angular sum of the applicator sectors covers the entirety of the angular cross section of the brush,
E9. if the angular sum does not cover the entirety of the angular cross section, return to step E6, otherwise proceed to step E10,
E10. user-validation of the brush designed.

Such additional steps make it possible to ensure that all of the applicator sectors have been selected and that the brush is complete.

Each of the selection steps may comprise a sub-step of displaying the selected applicator sector or group of applicator sectors, and a sub-step of validating the applicator sector or the group of applicator sectors.

In this way, the user is able to perfectly visualize the brush that this user is in the process of designing.

The applicator may further comprise a handle to which said brush is fixed,
during step E1. of providing a database, a secondary database comprising a plurality of handles to which the brush is able to be fixed, may also be provided,
and during step E3. of user-selection of at least a first applicator sector or group of applicator sectors from the database, a handle may also be selected so as to design the applicator complete with said brush.

In this way, the user may design the entire applicator complete, using the method according to the invention.

The invention also relates to a method for manufacturing a brush using a design method according to the invention, where during implementation of the design method, step E10. of validation of the brush comprises the following sub-steps:
E10.1 definition of information relating to the applicator sectors and/or groups of applicator sectors selected by the user,
E10.2 transmission of the information defined in steps E.10.1 to a manufacturing shop,
E10.3 manufacture of the brush by the manufacturing shop on the basis of the information transmitted.

With such a method, the user is able to manufacture a brush prototype directly from the computer, the elements necessary for manufacture being transmitted directly to the manufacturing shop after the user has validated the characteristics of the brush prototype that is to be manufactured.

During one of either step E3 of user-selection of at least a first applicator sector or group of applicator sectors, or step E10 of user-validation of the brush designed, provision is made for selection of at least one material from which said brush is to be manufactured.

Thus, the user is able to select the material(s) from which the brush designed in the context of the method of the invention will be manufactured.

As an alternative, during step E2. of provision of the compatibility rules, the compatibility rules may comprise rules governing the compatibility of materials of each of the applicator sectors and/or groups of applicator sectors, and during step E3. of user-selection of at least a first applicator sector or group of applicator sectors from the database, the user may also select a material of said first applicator sector or group of applicator sectors, the material and the first applicator sector or group of applicator sectors being selected in accordance with the materials-compatibility rules, and during step E4. of definition, from the database and on the basis of the compatibility rules, of a first set of applicator sectors and/or groups of applicator sectors, said compatible applicator sectors and/or groups of applicator sectors being compatible with the material selected in step E3.

In this way, all of the applicator sectors are compatible with the selected material, avoiding any risk of malformation which might result from the use of applicator sectors made in an inappropriate material.

During any one of the sub-steps E10.1, E10.2 and E10.3, the information relating to the sectors may be provided in or transcribed into the form of a succession of references, each of the references being associated with a respective applicator sector of the database,
The manufacturing sub-step E10.3 comprising the following actions:
E10.3A provision of a look-up table mapping each reference to a mold sector suitable for manufacturing the applicator sector associated with said reference,
E10.3B assembly of the mold sectors on the basis of the succession of references and of the look-up table so as to form an assembled mold corresponding to the brush comprising the applicator sectors selected by the user,
E10.3C molding of the brush using the assembled mold.

In this way, the technician in charge of manufacturing the brush is able to identify the molds associated with the applicator sectors that make up the brush. This results in ease of manufacture and a particularly low risk of error in the manufacture of the brush.

The invention also relates to a design and manufacturing assembly for the design and manufacture of a brush of a cosmetic product applicator, the design and manufacturing assembly comprising at least a computer and a manufacturing shop, the computer being configured to implement steps E1. to E10. of a manufacturing method according to the invention.

Such a design and manufacturing assembly makes it possible to implement a manufacturing method according to the invention and to enjoy the advantages associated therewith.

The invention also relates to a computer program product comprising computer code configured to implement the steps of a design method according to the invention when executed on a computer, the program product comprising instructions for performing the following steps:
provision of a database containing a plurality of applicator sectors and/or groups of applicator sectors suitable for contributing to the creation of the brush,
provision of compatibility rules governing the mutual compatibility of the applicator sectors and/or groups of applicator sectors,
user-selection of at least a first applicator sector or group of applicator sectors in the database,
definition, from the database and on the basis of the compatibility rules, of a first set of applicator sectors and/or groups of applicator sectors that are compatible with the at least one first applicator sector or group of applicator sectors selected,
user-selection of at least one applicator sector and/or group of applicator sectors from the first set.

Such a program product makes it possible to implement the method according to the invention and to enjoy the advantages connected therewith.

The invention also relates to a computer-readable recording medium storing the program product according to the invention.

### BRIEF DESCRIPTION OF THE DRAWINGS

The present invention will be better understood from reading the description of exemplary embodiments given by way of purely indicative and entirely nonlimiting example, while referring to the attached drawings in which:

FIGS. 1A and 1B illustrate, respectively, a perspective view of an example of a prototype applicator brush for cosmetic products which can be produced using a method according to the invention, and an exploded view of a number of examples of applicator sectors that can be used in the context of such production, the applicator sectors being shown arranged on a handle,

FIGS. 2A to 2C illustrate, respectively, a face-on view of two applicator sectors, one of a left-hand type and the other of a right-hand type, and views in lateral section and in perspective of an assembly of these two applicator sectors,

FIG. 3 illustrates a view in cross section of an assembly of two neutral applicator sectors,

FIGS. 4A to 4C illustrate, schematically and viewed in cross section, the rules of assembly that have to be observed in respect of the left-hand type and right-hand type applicator sectors,

FIGS. 5A to 5D illustrate, schematically and viewed in cross section, one example of incompatibility between two applicator sectors, one of left-hand type and one of right-hand type, and two examples of assembly where it is possible to assemble two sectors of right-hand type, respectively,

FIGS. 6A and 6B illustrate, respectively, a view in cross section and a view in perspective of one example of a group of applicator sectors without spikes so as to form a partial applicator referred to as a “comb”. These sectors being able to be selected as part of the implementation of the design method according to the invention,

FIG. 7 illustrates a flowchart of the design method for designing a brush according to the invention,

FIG. 8 illustrates a flowchart specifying the sub-steps that can be implemented during step E10 of validation of the brush designed,

FIG. 9 illustrates a flowchart specifying the actions that should be implemented during a sub-step E10.3 of manufacture of the brush designed,

FIG. 10 illustrates a design and manufacturing assembly for the design and manufacture of a brush of a cosmetic product applicator, comprising a computer for designing the brush and a manufacturing shop for manufacturing it,

FIG. 11 illustrates a design and manufacturing assembly for the design and manufacture of a brush of a cosmetic product applicator, according to an alternative of the invention based on the use of a server.

Parts that are identical, similar or equivalent bear the same numerical references in the various figures, so as to make it easier to switch attention from one figure to another.

In order to make the figures more legible, the various parts depicted therein are not necessarily drawn to the same scale,

The different possibilities (variants and embodiments) must be understood to be not mutually exclusive and to be able to be combined with one another.

### DETAILED DESCRIPTION OF PARTICULAR EMBODIMENTS

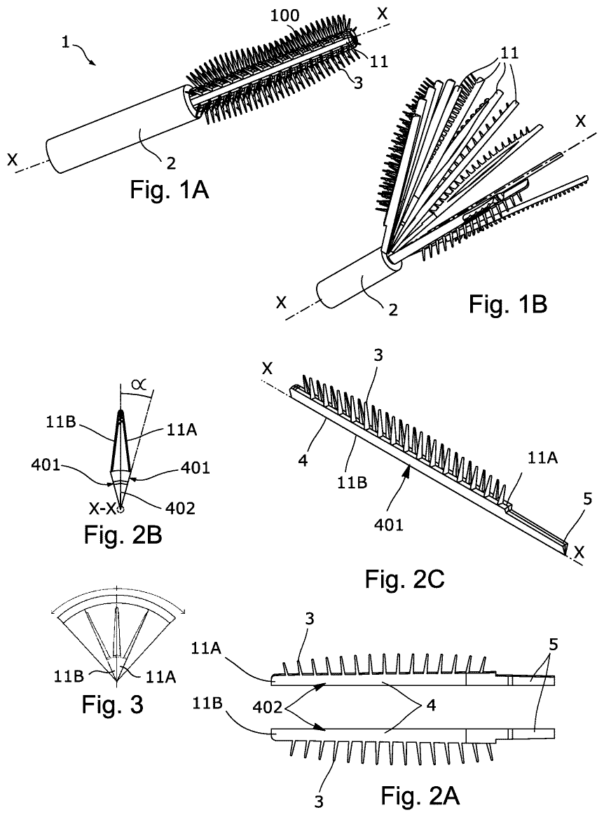

FIG. 1A illustrates one example of an applicator 1 having a brush 100 able to be designed during implementation of a method according to the invention.

Such a brush 100 is a brush of an applicator of fluid or pasty products to keratin fibers. The products may be cosmetic products or therapeutic products. The applicator 1 comprises, in addition to the brush itself, a handle 2 for manipulating the brush 100. It will be noted that, in a non-illustrated variant of the invention, the brush may be a branch devoted to applying a cosmetic product of the lips, notably with a view to coloring same or applying non-therapeutic care, such as hydration, or to the skin. Of course, the invention is not restricted to just these types of application of cosmetic product, and relates to any type of application of cosmetic product able to be achieved using a brush.

This brush extends along a longitudinal axis X-X and comprises several applicator sectors 11 each representing an angular section of said brush 100 about the longitudinal axis X-X. Of course, while a delineation of the sectors is featured in FIG. 1A, this is purely by way of illustration. Specifically, when the applicator sectors 11 are manufactured, generally by molding, they are produced as a single entity and there is no delineation between two adjacent applicator sectors 11.

Of course, the applicator 1 and its brush 100 which have been illustrated in FIG. 1A have been so for illustrative purposes. There are a great many models that may be designed in the context of implementation of the method according to the invention.

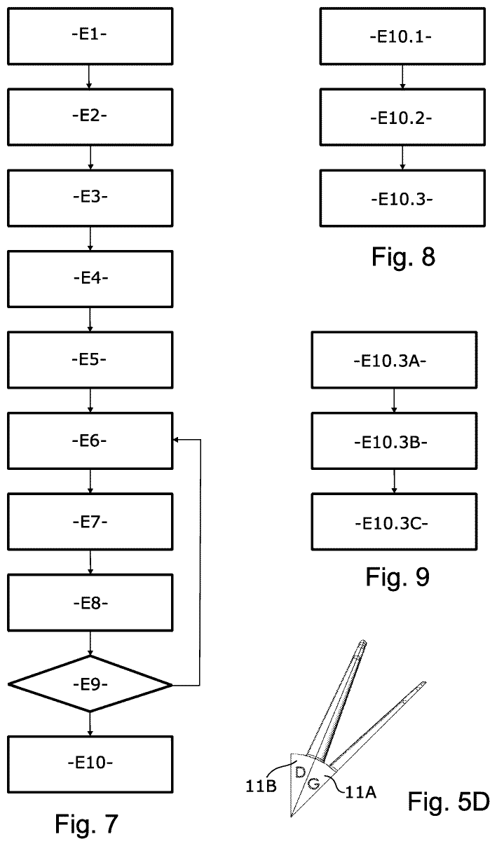

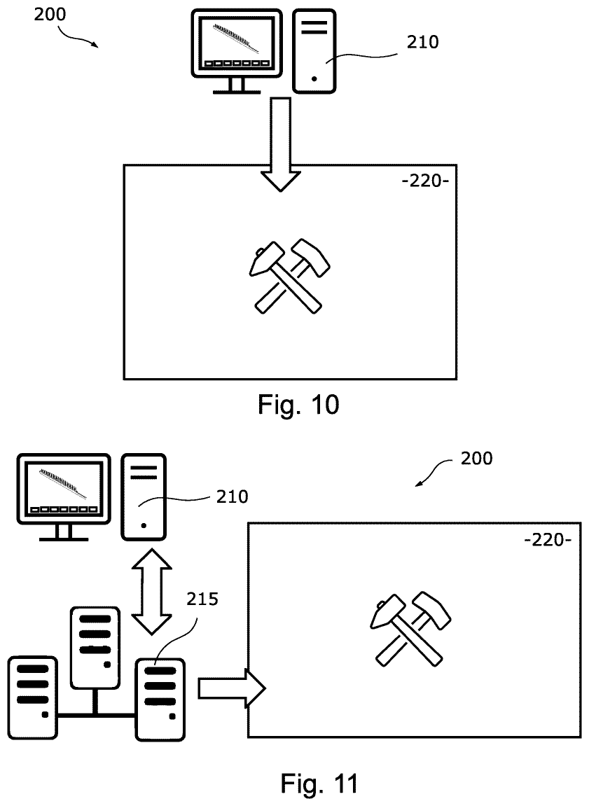

In accordance with the principle already set out in the context of application EP3893693 A1 and illustrated in FIG. 1B, it is possible, with such a system of applicator sectors 11, to select different types of applicator sectors 11. This FIG. 1B thus shows the handle 2 and a plurality of different applicator sectors 11, in an exploded view in order the better to show examples of applicator sectors 11. For further information regarding the examples of applicator sectors that can be selected in the context of the present invention, reference should be made to application EP3893693 A1, and more specifically to FIGS. 5A to 6C and to those parts of the description that discuss said figures.

It will be noted that the handle 2 is in the form of a hollow cylinder one face of which is open to form a recess to house an assembly end 5 (shown in FIGS. 2A and 2C) of the brush 100. Of course, such a shape is given merely by way of example, it being possible for the handle to have other shapes, as will be discussed later on in this document, without thereby departing from the scope of the invention.

In order to set out the principle of assembly as illustrated in the context of the present invention, FIGS. 2A to 2C illustrate the assembling of two applicator sectors 11A, 11B corresponding to the one same pair. As these figures show, the two applicator sectors 11A, 11B have in common a core 4 extending longitudinally from the assembly end 5. The core 4 is delimited laterally by a first lateral face 401 and a second lateral face 402 which are adjacent to one another and form an angle α between them. The angle α is comprised between 7.5° and 180°, for example. The assembly end 5, which when all the applicator sectors 11 have been selected is cylindrical, is intended to be housed in the recess of the handle 2 according to the invention. As shown in FIGS. 2A and 2C, the core 4 has spikes 3 of the brush. It will be noted that, in this particular instance, the spikes 3 are offset between each of the two applicator sectors 11A, 11B illustrated.

The two applicator sectors 11A, 11B shown in FIG. 2A are adjacent applicator sectors of the same type each having one lateral face 402 which is configured to come to bear against the other lateral face 402 of the other applicator sector of the same type, following a principle of right-hand applicator sectors D (the applicator sector 11A) and left-hand applicator sectors G (the applicator sector 11B). FIGS. 2B and 2C show such an arrangement of these applicator sectors 11A, 11B with their lateral faces 401, 402 assembled with one another.

According to another possibility of applicator sector shown in FIG. 3, the applicator sector 11A, 11B may be neutral and therefore compatible with any type of applicator sector 11. An applicator sector having this possibility does not need to be arranged in pairs as was the case with the applicator sectors 11A, 11B illustrated in FIG. 3.

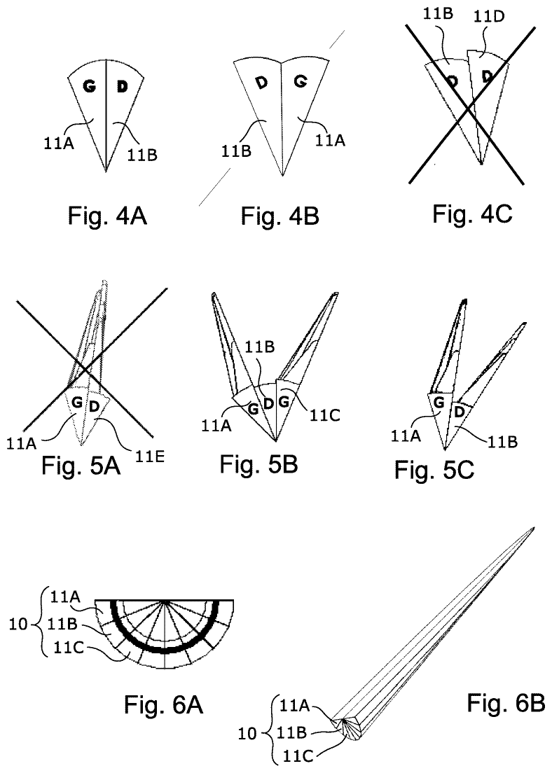

Thus, as these two examples of assembly of applicator sectors 11A, 11B during the design of a brush 100 according to the principle of the present invention show, it is necessary to conform to a certain number of design rules. FIGS. 4A to 5C illustrate certain examples of design rules. Of course, these design rules are provided by way of an example of how the invention is implemented and must be adapted to suited the types of brush that are to be designed, the applicator sectors that may be used in the context of this design and, of course, any manufacturing tooling, such as molds and injection molding machines, that may be used in the manufacture of the prototypes of said brush 100 designed.

It will be noted that, by convention, in FIGS. 4A to 6B, the left-hand applicator sectors 11A are referenced 11A and the right-hand applicator sectors 11B are referenced 11B. In the context of FIGS. 4C, 5B, 6A and 6B, the reference 11C is used to correspond to another applicator sector (third or second of a same type), which can then itself just as well be a right-hand sector as a left-hand sector.

Thus, it may be seen in FIGS. 4A to 4C that, for applicator sectors 11A, 11B that work in pairs, such as those illustrated in FIGS. 2A to 2C, during selection:
the right-hand applicator sector 11B necessarily has to be arranged to the right of the left-hand applicator sector 11A, as shown in FIG. 4A,
a left-hand applicator sector 11A necessarily has to be arranged to the right of a right-hand applicator sector 11B, as shown in FIG. 4B,
two applicator sectors of the one same type cannot succeed one another (here, this applies to two right-hand applicator sectors 11B, 11D but the same is equally true of two left-hand applicator sectors), as shown in FIG. 4C.

In other words, an applicator sector 11A, 11B of one of the types that are the right-hand type and the left-hand type must succeed and must be succeeded by an applicator sector 11B, 11A of the other type.

FIGS. 5A to 5D illustrate another example of rules regarding the assembly of applicator sectors 11A, 11B, 11E comprising spikes 3 that may exhibit incompatibilities. Specifically, as FIG. 5A shows, there is the possibility that certain applicator sectors 11A, 11E may not be compatible with one another even when they do respect the left-hand/right-hand rules set out above. It may be seen in FIG. 5A that the left-hand applicator sector 11A is not compatible with the right-hand applicator sector 11E because the spikes 3 that face one another have different heights. Likewise, according to another possibility for incompatibility, the spikes of these two applicator sectors 11A, 11E might also have pitch spacings along the longitudinal axis X-X of the applicator that might not be compatible with one another. As a result, assembling these two applicator sectors 11A, 11E would not enable the formation of a row suitable for applying a cosmetic product, so this assembly needs to be excluded by means of suitable rules.

Nevertheless, as shown in FIGS. 5B, 5C, it is possible to assemble these two types of applicator sector 11A, 11C (here in their “left-hand” versions) by arranging between them an intermediate sector 11B that does not have a spike 3. According to another possibility, as shown in FIG. 5C, it is possible to assemble these two applicator sectors with one another in such a way that the face of one which has the spikes 3 bears against the face of the other which does not have spikes 3, so reversing them. FIG. 5D shows an arrangement of a right-hand applicator sector 11B with a left-hand applicator sector 11A that complement one another, the spikes 3 of the one coinciding with the spikes of the other.

It will also be noted that, in the context of the invention, it is possible to provide groups 10 of applicator sectors 11A, 11B, 11C, like that illustrated in FIGS. 6A and 6B. Such a group is a set of preselected applicator sectors that perform a function of benefit to the user. Thus, for example, in the case illustrated in FIGS. 6A and 6B, eight applicator sectors 11A, 11B, 11C without a spike 3 are assembled to enable the formation of a spike-free brush half. Thus, a user seeking a brush comprising spikes on just one side may select such a group 10 so as to form half their brush in a single selection. In the same way, it is possible to provide brush quarters, brush thirds or brush halves having spikes 3 to a standard arrangement so that the user can, in a single selection, obtain a desired brush function.

It will also be noted that, according to one possibility of the invention, such a group 10 of applicator sectors 11A, 11B, 11C may also be designed by the user. For example, the user may select a first arrangement of two or four applicator sectors 11A, 11B, 11C that form a first group 10 and then repeat this group 10 of applicator sectors 11A, 11B, 11C.

On the basis of these examples of rules and of these different possibilities regarding the arrangement of applicator sectors 11, it is thus possible to implement a computer-aided design method for the design of a brush 100 of a cosmetic product applicator 1 according to the invention. In accordance with the flow diagram illustrated in FIG. 6, such a design method may comprise the following steps:
E1. provision of a database containing a plurality of applicator sectors 11, 11A, 11B, 11C and/or group 10 of applicator sectors 11, 11A, 11B, 11C suitable for contributing to the creation of the brush 100,
E2. provision of compatibility rules governing the mutual compatibility of the applicator sectors 11, 11A, 11B, 11C and/or groups 10 of applicator sectors 11, 11A, 11B, 11C,
E3. user-selection of at least a first applicator sector 11, 11A, 11B, 11C or group 10 of applicator sectors 11, 11A, 11B, 11C in the database,
E4. definition, from the database and on the basis of the compatibility rules, of a first set of applicator sectors 11, 11A, 11B, 11C and/or groups 10 of applicator sectors 11, 11A, 11B, 11C that are compatible with the at least one first applicator sector 11, 11A, 11B, 11C or group 10 of applicator sectors 11, 11A, 11B, 11C selected in step E3,
E5. user-selection of at least one applicator sector 11, 11A, 11B, 11C and/or group 10 of applicator sectors 11, 11A, 11B, 11C from the first set,
E6. definition, from the database and on the basis of the compatibility rules, of a subsequent set of applicator sectors 11, 11A, 11B, 11C and/or groups 10 of applicator sectors 11, 11A, 11B, 11C that are compatible with the applicator sector 11, 11A, 11B, 11C or the group 10 of applicator sectors 11, 11A, 11B, 11C selected in the preceding selection step E5., E7.,
E7. user-selection of at least one subsequent applicator sector 11, 11A, 11B, 11C or group 10 of applicator sectors 11, 11A, 11B, 11C from the subsequent set,
E8. verification whether the angular sum of the applicator sectors covers the entirety of the angular cross section of the brush,
E9. if the angular sum does not cover the entirety of the angular cross section, return to step E6., otherwise proceed to step E10.,
E10. user-validation of the brush designed.

According to one possibility of the invention, during the step E3 of user-selection of at least a first applicator sector 11, 11A, 11B, 11C or group 10 of applicator sectors 11, 11A, 11B, 11C and step E10 of user-validation of the brush 100 designed, provision is made for selection of at least one material from which said brush is to be manufactured. As a preference, step E10 comprises a sub-step of selection of the at least one material from which said brush is to be manufactured.

It will be noted that, according to this possibility of the invention, the user may have the possibility of selecting a plurality of materials or groups of materials so as to be able to design a plurality of prototypes and thus, from these different prototypes, identify which material is most suitable for the brush 100.

It will also be noted that, in the context of this same possibility of the invention, provision may be made, for example in the context of the validation step E10, for the user to have the possibility of changing the material or group of materials of their brush should the first material tested not have been found to be suitable. Such a possibility allows the user to avoid having to implement the steps E1 to E9 again when only the material of the brush needs changing.

According to another possibility of the invention which is a variant of the above possibility, during step E2. of provision of the compatibility rules, the compatibility rules may comprise rules governing the compatibility of materials of each of the applicator sectors 11, 11A, 11B, 11C and/or groups 10 of applicator sectors 11, 11A, 11B, 11C, and during step E3. of user-selection of at least a first applicator sector 11, 11A, 11B, 11C or group 10 of applicator sectors 11, 11A, 11B, 11C from the database, the user also selects a material of said first applicator sector 11, 11A, 11B, 11C or group 10 of applicator sectors 11, 11A, 11B, 11C, the material and the first applicator sector 11, 11A, 11B, 11C or group 10 of applicator sectors 11, 11A, 11B, 11C being selected in accordance with the materials-compatibility rules. According to this possibility, during step E4 of defining, from the database and on the basis of the compatibility rules, the first set of applicator sectors 11, 11A, 11B, 11C and/or groups 10 of applicator sectors 11, 11A, 11B, 11C, said compatible applicator sectors 11, 11A, 11B, 11C and/or groups 10 of applicator sectors 11, 11A, 11B, 11C are compatible with the material selected in step E3.

According to another possibility of the invention, during step E1., a secondary database comprising a plurality of handles 2 to which the brush 100 is able to be fixed, may also be provided. According to this possibility, during step E3. of user-selection of at least a first applicator sector 11, 11A, 11B, 11C or group 10 of applicator sectors 11, 11A, 11B, 11C from the database, a handle 2 may also be selected so as to design the applicator complete with said brush 100.

Likewise, advantageously, each of the selection steps E3., E5., E7. may comprise a sub-step of displaying the selected applicator sector 11 or group 10 of applicator sectors 11, and a sub-step of validating the applicator sector 11 or the group 10 of applicator sectors 11. This display may be performed in such a way as to show the applicator sector 11 or the group 10 of applicator sectors 11 assembled with the applicator sector(s) that have been selected beforehand. In this way, the user is able to verify that the applicator sector 11 selected is the correct one and may potentially verify that it is properly suited to the other applicator sector(s) selected beforehand.

It will be noted that, likewise, in the context of the subsequent selection steps E5., E7. of selecting an applicator sector, the possibility of identifying an applicator sector 11 or group 10 of applicator sectors to be modified, may also be offered. According to this possibility, the first set or the subsequent set comprises only applicator sectors 11 capable of replacing the identified applicator sector 11 (or one of the applicator sectors 11 of the group 10). The subsequent selection step E5., E7. then consists in selecting, from the first set, or the subsequent set, said applicator sector 11 that is going to replace the identified applicator sector 11 (or one of the applicator sectors 11 of the group 10).

Such a design method may advantageously be implemented in the context of a method for manufacturing an applicator brush. According to this possibility, the manufacturing method, aside from implementing the design method as described hereinabove, offers its step E10 of user-validation of the brush designed, and which, as shown in FIG. 7, comprises the following sub-steps:
E10.1 definition of information relating to the applicator sectors 11, 11A, 11B, 11C and/or groups 10 of applicator sectors 11, 11A, 11B, 11C selected by the user,
E10.2 transmission of the information defined in steps E.10.1 to a manufacturing shop 220,
E10.3 manufacture of the brush 100 by the manufacturing shop 220 on the basis of the information transmitted.

In the context of conventional implementation of such a manufacturing method, during any one of the sub-steps E10.1, E10.2 and E10.3, the information relating to the applicator sectors 11, 11A, 11B, 11C may be provided in or transcribed into the form of a succession of references, each of the references being associated with a respective applicator sector 11, 11A, 11B, 11C of the database. According to this possibility, the manufacturing sub-step E10.3 may comprise the following actions:
E10.3A provision of a look-up table mapping each reference to a mold sector suitable for manufacturing the applicator sector 11, 11A, 11B, 11C associated with said reference,
E10.3B assembly of the mold sectors on the basis of the succession of references and of the look-up table so as to form an assembled mold corresponding to the brush 100 comprising the applicator sectors selected by the user,
E10.3C molding of the brush using the assembled mold.

Such a manufacturing method may notably be implemented using a design and manufacturing assembly 200 comprising, as illustrated in FIG. 9, at least a computer 210 and a manufacturing shop 220.

While of course, the computer 210 may be configured to implement the steps E1. to E10., there are other configurations which may allow a method according to the invention to be implemented.

Thus, according to one example of the invention, the steps E1 to E10 may be implemented by means of a dedicated site. The steps are implemented on a server 215, the user accessing the server via a computer 210 accessing a site hosted by the server 215. Thus, according to this example, the server 215 hosts, in addition to the dedicated site, the databases containing the applicator sectors, the rules, the handles/materials, where applicable, and the look-up table mapping molds to applicator sectors. Of course, if the selection steps are performed by the user by means of a dedicated website, the selection is performed by the interaction between the computer 210 and the server 215 and therefore by the server 215 itself. Thus, in the present example, it is the server 215 that implements the method.

Of course, other implementation possibilities may be conceivable, such as for example a design produced on the computer 210 using a dedicated program while accessing the database of rules and applicator sectors that are hosted on a server 215.

It will be noted that the invention also relates to a computer program product comprising computer code configured to implement the steps of a design or manufacturing method as described hereinabove when executed on a computer. Likewise, the invention relates to a computer-readable recording medium storing such a program product.

It will also be noted that the design rules may be provided in different ways and may notably be included directly in the database containing the applicator sectors, this database then associating each of the applicator sectors with those that are compatible with them. According to this possibility, the steps E1 and E2 may be concomitant, the rules then being provided directly incorporated into the database, for example in the form, for each applicator sector 11, of a list of applicator sectors 11 or of types of applicator sector 11 with which said applicator sector 11 is compatible.

1. A method for the computer-aided design of a brush of a cosmetic-product applicator, the brush extending along a longitudinal axis and comprising a plurality of applicator sectors each representing an angular section of said brush about the longitudinal axis, the method comprising the following steps:
E1. provision of a database containing a plurality of applicator sectors and/or groups of applicator sectors suitable for contributing to the creation of the brush,
E2. provision of compatibility rules governing the mutual compatibility of the applicator sectors and/or groups of applicator sectors,
E3. user-selection of at least a first applicator sector or group of applicator sectors in the database,
E4. definition, from the database and on the basis of the compatibility rules, of a first set of applicator sectors and/or group of applicator sectors that are compatible with the at least one first applicator sector or group of applicator sectors selected in step E3.,
E5. user-selection of at least one applicator sector and/or group of applicator sectors from the first set.

2. The method for the computer-aided design of a brush of a cosmetic-product applicator as claimed in claim 1 further comprising, after the step E5, the following steps:
E6. definition, from the database and on the basis of the compatibility rules, of a subsequent set of applicator sectors and/or groups of applicator sectors that are compatible with the applicator sector or the group of applicator sectors selected in the preceding selection step E5, E7,
E7. user-selection of at least one subsequent applicator sector or group of applicator sectors from the subsequent set,
E8. verification whether the angular sum of the applicator sectors covers the entirety of the angular cross section of the brush,
E9. if the angular sum does not cover the entirety of the angular cross section, return to step E6, otherwise proceed to step E10,
E10. user-validation of the brush designed.

3. The method for the computer-aided design of a brush of a cosmetic-product applicator as claimed in claim 1, wherein each of the selection steps comprises a sub-step of displaying the selected applicator sector or group of applicator sectors, and a sub-step of validating the applicator sector or the group of applicator sectors.

4. The method for the computer-aided design of a brush of a cosmetic-product applicator as claimed in claim 1, wherein the applicator further comprises a handle to which said brush is fixed,
wherein, during step E1. of providing a database, a secondary database comprising a plurality of handles to which the brush is able to be fixed, is also provided,
and wherein, during step E3. of user-selection of at least a first applicator sector or group of applicator sectors from the database, a handle is also selected so as to design the applicator complete with said brush.

5. The method for the computer-aided design of a brush of a cosmetic-product applicator as claimed in claim 2, wherein during one of either step E3 of user-selection of at least a first applicator sector or group of applicator sectors or step E10 of user-validation of the brush designed, provision is made for selection of at least one material from which said brush is to be manufactured.

6. A method for manufacturing a brush using a method for the computer-aided design of a brush of a cosmetic-product applicator as claimed in claim 2, wherein, during implementation of the design method, step E10. of validation of the brush comprises the following sub-steps:
E10.1 definition of information relating to the applicator sectors and/or groups of applicator sectors selected by the user,
E10.2 transmission of the information defined in steps E.10.1 to a manufacturing shop,
E10.3 manufacture of the brush by the manufacturing shop on the basis of the information transmitted.

7. The method for manufacturing a brush as claimed in claim 6, wherein, during any one of the sub-steps E10.1, E10.2 and E10.3, the information relating to the sectors is provided in or transcribed into the form of a succession of references, each of the references being associated with a respective applicator sector of the database,
and wherein the manufacturing sub-step E10.3 comprises the following actions:
E10.3A provision of a look-up table mapping each reference to a mold sector suitable for manufacturing the applicator sector associated with said reference,
E10.3B assembly of the mold sectors on the basis of the succession of references and of the look-up table so as to form an assembled mold corresponding to the brush comprising the applicator sectors selected by the user,
E10.3C molding of the brush using the assembled mold.

8. A design and manufacturing assembly for the design and manufacture of a brush of a cosmetic product applicator, the design and manufacturing assembly comprising at least a computer and a manufacturing shop, the computer being configured to implement steps E1. to E10. of a manufacturing method as claimed in claim 6.

9. A computer program product comprising computer code configured to implement the steps of a design method as claimed in claim 1 when executed on a computer, the program product comprising instructions for performing the following steps:
provision of a database containing a plurality of applicator sectors and/or groups of applicator sectors suitable for contributing to the creation of the brush,
provision of compatibility rules governing the mutual compatibility of the applicator sectors and/or groups of applicator sectors,
user-selection of at least a first applicator sector or group of applicator sectors in the database,
definition, from the database and on the basis of the compatibility rules, of a first set of applicator sectors and/or groups of applicator sectors that are compatible with the at least one first applicator sector or group of applicator sectors selected,
user-selection of at least one applicator sector and/or group (10) of applicator sectors from the first set.

10. A computer-readable recording medium storing the program product as claimed in claim 9.
